(19) United States
(12) Patent Application Publication
(10) Pub. No.: US 2023/0377606 A1
(43) Pub. Date: Nov. 23, 2023

(54) VIDEO EDITING PROJECTS USING SINGLE BUNDLED VIDEO FILES

(71) Applicant: Microsoft Technology Licensing, LLC, Redmond, WA (US)

(72) Inventors: Soeren Balko, Brookfield (AU); Huan Ji, Sydney (AU); Alexander Dreiling, Brisbane (AU); Brock Andrew Kenzler, Brisbane (AU)

(73) Assignee: Microsoft Technology Licensing, LLC, Redmond, WA (US)

(21) Appl. No.: 17/751,411

(22) Filed: May 23, 2022

(51) Int. Cl. G11B 27/031

(52) U.S. Cl. CPC G11B 27/031

(57) ABSTRACT

Techniques are described for managing video editing projects using single bundled video files. A single bundled video file is a new type of file that is in a video container format and that can be used to store and re-create a video editing project. A single bundled video file comprises visible media streams, video editing project data, and hidden video editing components. The hidden video editing components (e.g., comprising media assets) and video editing project data can be used to re-create a video editing project.

### BACKGROUND

People use video to tell engaging visual stories. The creator movement is characterized by a strong desire for viewers of video content to also create and distribute their own videos. Online video platforms are poised to drive engagement by offering their users the ability to both watch and create videos. However, merely adding video editing capabilities to a viewing-only service routinely fails to turn viewers in into creators. Non-professional video creators face a “creativity gap” where they lack ideas or a solid understanding of the creative process. They also suffer a “skills gap” which makes it difficult for them to turn an idea into a well put together video that is engaging to other users. Such gaps in creativity and/or skill often make it exceedingly hard to create a video, eventually culminating in a “motivation gap.”

Video editing software solutions have tried to address these issues through curated video templates and other pre-made video building blocks. While this works reasonably well in some situations, it also constrains the variety of content that can be produced, often resulting in sterile looking videos that lack differentiation. Another attempt to overcome these issues are the use of fundamentally simplified editing paradigms, such as simple scene-based editors. While easy to use, the expressive freedom of creators is severely hampered by such simplified editing paradigms.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for managing video editing projects using single bundled video files. For example, operations can be performed for determining that a file being opened is a single bundled video file, where the single bundled video file is compliant with a video container format, and where the single bundled video file comprises both visible media streams and hidden video editing components. The operations can further comprise, responsive to determining that the file is a single bundled video file, re-creating a video editing project from the single bundled video file using, at least in part, the hidden video editing components, comprising: obtaining video editing project data describing the video editing project from the single bundled video file, obtaining media assets using, at least in part, the video editing project data from the singled bundled media file, and re-creating the video editing project using, at least in part, the video editing project data and the media assets, where re-creating the video editing project comprises re-creating a video editing timeline of the video editing project. The re-created video editing project is editable by a user.

As another example, operations for managing video editing projects using single bundled video files can comprise receiving video editing commands from a user performing corresponding video editing operations on a video editing project and saving the video editing project as a single bundled video file that is compliant with a video container format. Saving the video editing project comprises: exporting one or more media streams from the video editing project, where the one or more exported media streams are stored within the single bundled video file as one or more corresponding visible media streams, storing, within the single bundled video file, video editing project data describing the video editing project, and storing, within the single bundled video file, hidden video editing components, where the hidden video editing components comprise media assets used in the video editing project. The video editing project data and the hidden video editing components are usable to re-create the video editing project.

Technologies are described for providing a single bundled video file compliant with a video container format, where the single bundled video file is for a video editing project. The single bundled video file comprises: one or more visible media streams, where the one or more visible media streams are stored as one or more corresponding audio or video tracks according to the video container format, and where the one or more visible media streams are playable by a media player, video editing project data describing the video editing project, and hidden video editing components, wherein the hidden video editing components comprise media assets used in the video editing project. The video editing project data and the hidden video editing components are usable to re-create the video editing project.

### BRIEF DESCRIPTION OF THE DRAWINGS

FIG. 1 is a diagram depicting a single bundled video file in a video container format.

FIG. 2 is a diagram depicting a single bundled video file in a video container format, including bundled media assets and external media assets.

FIG. 3 is a diagram depicting a single bundled video file in a video container format, including reconstructed media assets and concatenated media assets.

FIG. 4 is a flowchart of an example method for managing video editing projects using single bundled video files, including re-creating a video editing project from a single bundled video file.

FIG. 5 is a flowchart of an example method for managing video editing projects using single bundled video files, including saving a video editing project to a single bundled video file.

FIG. 6 is a diagram of an example computing system in which some described embodiments can be implemented.

FIG. 7 is an example cloud-support environment that can be used in conjunction with the technologies described herein.

### DETAILED DESCRIPTION

### Overview

The following description is directed to technologies for managing video editing projects using single bundled video files. A single bundled video file is a new type of file that is in a video container format and that can be used to store and re-create a video editing project. A single bundled video file comprises both visible media streams and hidden video editing components. The single bundled video file also comprises video editing project data.

The hidden video editing components (e.g., comprising media assets) and video editing project data can be used to re-create a video editing project by virtue of storing the hidden video editing components in a technical manner that is compliant with the video container format being used (e.g., as data tracks in a Moving Picture Experts Group (MPEG)-4 Part 14, also referred to as MP4, container). The visible media streams are playable by a media player, even when the media player is not configured to process the hidden video editing components.

### Example Video Editing

In some situations, the technologies described herein involve video editing. Video editing refers to the process of combining various video editing elements, including media assets (e.g., video content, images, audio files, etc.), effects (e.g., filters, transitions, distortions, etc.), different types of synthetic content (e.g., motion titles, animations, etc.), and/or other elements to create a single continuous video file. In a typical video editing scenario, a user uses video editing software to creatively select and insert these elements into a video editing project. The video editing project represents the eventual output video in a temporal manner (e.g., using a timeline defining when different elements appear) and a spatial manner (e.g., locations where certain video elements will be shown in the video's dimensions). Users typically iterate over applying, inspecting, and refining video editing operations, such as to place a specific media asset at a particular time offset, to trim the specific media asset to a desired length, to apply an effect on top of the specific media asset, etc.

Video editing is performed using video editing software on a computing device (e.g., a desktop or laptop computer, a tablet, a smart phone, or another type of computing device). The video editing software can be a video editing software package or app that is installed on the computing device, a browser-based video editor application that runs in a web browser, a cloud-based video editing service, or another type of video editing software solution.

With traditional video editing software, the user will edit the video editing project and, when it is complete, the user will export the video editing project as an exported media file (e.g., as an MP4 file). The exported media file contains encoded audio and/or video media streams. A media player can then be used to play back the encoded audio and/or video media streams from the exported media file so long as the media player supports the container format and audio and video codecs being used. However, if someone wants to perform additional video editing, the exported media file cannot be used to re-create the video editing project as it existed when it was exported because the video editing components are no longer present in an editable form (e.g., they have been trimmed, composited, encoded, etc.). For example, a video clip that has been composited with a title overlay will not be present in the exported media file in its unencoded state and without the composited title. As another example, the original makeup of the video editing project out of individual scenes is lost in the exported video stream.

People use video to tell engaging visual stories. The creator movement is characterized by a strong desire for viewers of video content to also create and distribute their own videos. Online video platforms are poised to drive engagement by offering their users the ability to both watch and create videos or to offer blended experiences where their users can both watch and modify (edit) videos at the same time. However, merely adding video editing capabilities to a viewing-only service routinely fails to turn viewers in into creators. Non-professional video creators face a “creativity gap” where they lack ideas or a solid understanding of the creative process. They also suffer a “skills gap” which makes it difficult for them to turn an idea into a well put together video that is engaging to other users. Such gaps in creativity and/or skill often make it exceedingly hard to create a video, eventually culminating in a “motivation gap.” Video editing software solutions have tried to address these issues through curated video templates and other pre-made video building blocks. While this works reasonably well in some situations, it also constrains the variety of content that can be produced, often resulting in sterile looking videos that lack differentiation. Another attempt to overcome these issues are the use of fundamentally simplified editing paradigms, such as simple scene-based editors where users put together videos as a sequence of independent scenes. While easy to use, the expressive freedom of creators is severely hampered by such simplified editing paradigms (e.g., by not offering the capabilities of a timeline-based video editor).

The technologies described herein address these issues by making it possible to remix existing videos (e.g., existing videos from other authors). When remixing an existing video, a creator can re-use portions of an existing video editing project and/or add their own contributions. Some example remixing scenarios are as follows. One example remixing scenario is a reaction video where creators record themselves watching, and commenting on, existing videos (e.g., as a picture-in-picture talking head overlay). Another example remixing scenario is where a creator incorporates the visual language in other creators' videos (e.g., by re-using footage, music, graphical elements, and/or other elements from their videos). Another example remixing scenario is where a creator participates in a video “chain mail” where the creator modifies third party videos, in turn making their changes available to others (e.g., in a video-based anthology to a conversation thread).

The technologies described herein provide additional advantages. For example, the use of a single bundled video file that contains both visible media streams and hidden video editing components allows a media player to play back the visible media streams while ignoring the hidden video editing components. In this way, the single bundled video file is backward compatible with media players that are not configured to process the hidden video editing components. As another example advantage, media players that are configured to process the hidden video editing components could play back the audio and/or video streams using the hidden video editing components rather than the visible media streams. For example, playback from the hidden video editing components can provide improved quality (e.g., the hidden video editing components can be of higher resolution, higher frame rate, less compressed, etc.).

As another example advantage, the single bunded video file is self-contained and allows video editors to re-create the underlying video editing project with all of the associated video editing elements, so that the video editing project can be remixed to create new media streams (e.g., exported to create new visible media streams using the single bundled video file and/or exported to create new media streams using a traditional media file). As another example advantage, the single bundled video file is easily portable and can be uploaded to a website, shared on a file sharing system, attached to an email, or stored on a portable storage device, which avoids the complexity (and source of mistakes) of having to share multiple files (e.g., as a video project file in addition to multiple media asset files).

### Terminology

The term “single bundled video file” refers to a single computer file that contains visible media streams, video editing project data, and hidden video editing components. The visible media streams are playable by a media player even when the media player has not been programmed to access the hidden video editing components. The single bundled video file is compliant with a video container format (e.g., an MP4 file configured according to the MP4 container format, an AVI file configured according to the AVI container format, or a file in another suitable video container format).

The term “visible media stream” refers to an audio or video visible media stream that is present in a media file and is playable by a media player. For example, a single bundled video file can contain one or more audio and/or video visible media streams according to a video container format. A media player that supports the container format, and the audio and video codecs being used, can access and play back visible audio streams and visible video streams stored within. The single bundled video file can also contain other visible media elements, such as subtitles.

The term “hidden video editing components” refers to elements that do not form part of the visible media streams. The hidden video editing components are elements used by video editing software that are ignored by standard media players (i.e., media players that are not configured to process the hidden video editing components of a single bundled video file) and standard video editing software (i.e., video editing software that is not configured to process the hidden video editing components of a single bundled video file). The hidden video editing components can comprise media assets, such as audio clips, video clips, images, and/or other elements used by the video editing project.

The term “video editing timeline” refers to the timeline used by video editing software. The timeline indicates the various elements (e.g., media assets, effects, etc.) that make up the video editing project, along with their various properties (e.g., start offset, duration, effect type, settings, etc.).

The term “video editing project” refers to a project for organizing video editing elements (also referred to as just elements) using a video editing timeline within video editing software. The video editing project typically uses a graphical computer user interface to display the video editing timeline and allow the user to edit the elements of the timeline. However, the video editing software can also use a non-graphical user interface (e.g., a text-based user interface) or be implemented, at least in part, in an automated fashion (e.g., a machine learning approach to turn a collection of media into a video).

### Example Single Bundled Video File

In the technologies described herein, a new type of file, referred to as a singled bundled video file, is provided. The single bundled video file is a single playable media file that is compliant with a video container format (e.g., an MP4 file that is compliant with the MP4 video container standard).

The single bundled video file contains both visible media streams and hidden video editing components. The visible media streams are the result of exporting the video editing project and are playable by a media player even when the media player has not been programmed to access the hidden video editing components. The hidden video editing components comprise media assets used by the video editing project. The single bundled video file also contains video editing project data.

The video editing project data represents structural information about the video project's composition (e.g., the number of tracks, the arrangement and duration of visual and/or audible building blocks included in the tracks, properties of visual and/or audible building blocks, etc.) and the configurable settings of the building blocks (e.g., the color and label of a motion title, transition settings, etc.). In some implementations, permission information is stored within the single bundled video file (e.g., as part of the video editing project data or other metadata). For example, permissions can be provided for allowing (or disallowing) users (or certain users) to remix the video editing project, or to provide other limits or constraints on the use of the hidden video editing components. In some implementations, the video editing project data is coded using a string representation (e.g., as a serialized JSON document) and stored in a key-value metadata field of the container file.

The media assets (e.g., audio, video, and image elements) are available to use within the video editing project (e.g., they can be placed on the video editing timeline). For example, when a single bundled video file is opened by video editing software that is configured to process the hidden video editing components, a video editing project can be recreated using, at least in part, the video editing project data and the media assets.

In the technologies described herein, media assets can be bundled within the singled bundled media file as bundled media assets. Bundled media assets (e.g., audio clips, video clips, images, etc.) are stored within the single bundled video file. In some implementations, bundled media assets are stored as hidden tracks according to the video container format. For example, using the MP4 contain format, the hidden tracks can be stored as secondary streams (e.g., as secondary data streams).

In some implementations, when bundled media assets are stored in a single bundled video file (e.g., when the single bundled video file is saved), they are processed to reduce their size. For example, the bundled media assets can be trimmed to the interval used by the video editing project (e.g., if only 10 seconds of a 30-second video clip is used in the video editing project, then the video clip can be trimmed to the 10 seconds that are used and saved as a bundled media asset). As another example, the bundled media asset can be reduced in size by reducing the sampling rate, resolution, and/or frame rate, or by re-encoding (e.g., using a more efficient codec, etc.). In some cases, such as when a bundled media asset is no longer actively used in the video editing project (e.g., it has been removed from the timeline), or was added to the video editing project but then never used on the timeline, it is removed from the singled bundled media file.

In the technologies described herein, media assets can be referenced, within the single bundled video file, as external media assets. For example, media asset information that is stored within the single bundled video file (e.g., as part of the video editing project data) can reference external media assets (e.g., audio clips, video clips, images, etc.) that are stored at external locations (external to the single bundled video file). The external location could be a referenced using a uniform resource locator (URL) or in another manner (e.g., a file location within a file system accessible to recipients of the single bundled video file). For example, the media asset information could identify the external media assets within a stock media library.

In the technologies described herein, media assets can be reconstructed from the visible media streams that are present in the single bundled video file. Specifically, when a media asset can be reconstructed from the visible media streams, the media asset is not included separately within the single bundled video file. Instead, the media asset information within the single bundled video file identifies the media asset as a reconstructed media asset by identifying where the reconstructed media asset is present within the visible media streams. For example, the media asset information can identify a time range where the reconstructed media asset information can be obtained from a given visible media stream (e.g., a 15 second portion of a video stream at a specific time offset). In some implementations, reconstructed media assets need to be identically present within the visible media streams to be obtained in this manner (e.g., without any overlays, transitions, occlusions etc.).

In the technologies described herein, media assets can be generated by concatenating portions of visible media streams with media assets stored within the single bundled video file. Specifically, a concatenated media asset is a media asset that is generated using at least one portion of a visible media stream and at least one portion of a hidden video editing component. For example, a first portion of video could be obtained from a 20 second time range of a visible video stream and concatenated with a second video clip (e.g., a 5-second video clip) stored as a hidden media asset (e.g., a bundled media asset). Generating media assets using concatenation can be useful where the media asset is present in the visible media streams, but a portion of it is occluded (e.g., has a title overlay). In this situation, just the occluded portion can be included as a hidden video editing component. This technology also provides advantages in terms of reduced computer storage and bandwidth (due to the smaller size of the single bundled video file) as the entire media asset need not be duplicated within the single bundled video file.

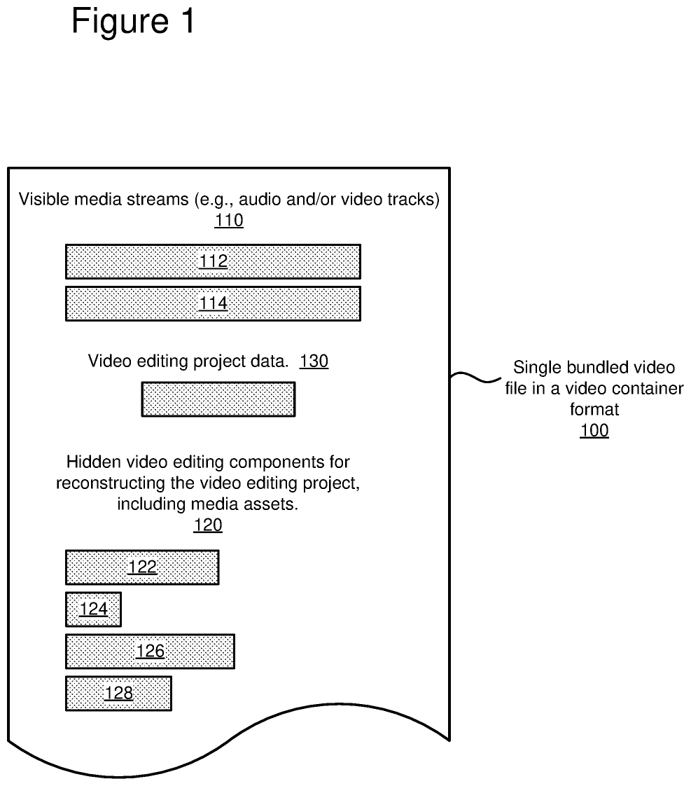

FIG. 1 is a diagram depicting a single bundled video file 100 in a video container format. For example, the single bundled video file 100 could be an MP4 file. The single bundled video file 100 contains visible media streams 110 (e.g., one or more visible audio and/or video streams). In this example, the single bundled video file 100 contains visible media stream 112 (e.g., a visible video stream) and visible media stream 114 (e.g., a visible audio stream). For example, the visible media stream 112 could be a visible video stream encoded according to the H.264 video coding standard or another video coding standard, and the visible media stream 114 could be a visible audio stream encoded according to the advanced audio coding (AAC) audio coding standard or another audio coding standard.

The single bundled video file 100 also contains hidden video editing components 120. The hidden video editing components 120 are used for reconstructing the video editing project, and comprise media assets. For example, hidden video editing components 122, 124, 126, and 128 are depicted. These hidden video editing components are stored within the single bundled video file 100. For example, hidden video editing component 122 could be a hidden video media asset (e.g., a video clip). As another example, hidden video editing component 124 could be a hidden audio media asset (e.g., an audio clip).

The single bundled video file 100 also contains video editing project data 130 (e.g., stored in metadata field(s) of the single bundled video file 100 according to the container format). The video editing project data 130 can include structural information for the video editing project as well as information (e.g., media asset information) for obtaining various media assets used by the video editing project. For example, the video editing project data 130 can be used to obtain external media assets, reconstructed media assets, concatenated media assets, and/or other types of media assets.

The visible media streams 110 are accessible and playable by a media player that reads the single bundled video file 110 even when the media player is not programmed to access the hidden video editing components 120. On the other hand, software (e.g., video editing software, and/or other types of computer software) that is programmed to process the hidden video editing components 120 and video editing project data 130 can reconstruct a video editing project that is then editable by a user (e.g., to reconstruct a timeline allowing the user to edit the video editing project by performing video editing operations, and that utilizes the hidden video editing components 120 and the video editing project data 130). Such software that is programmed to process the hidden video editing components 120 and video editing project data 130 can also save a single bundled video file 110, including exporting media streams that are saved as visible media streams (e.g., visible media streams 110) and saving hidden video editing components (e.g., hidden video editing components 120) and video editing project data (e.g., video editing project data 130).

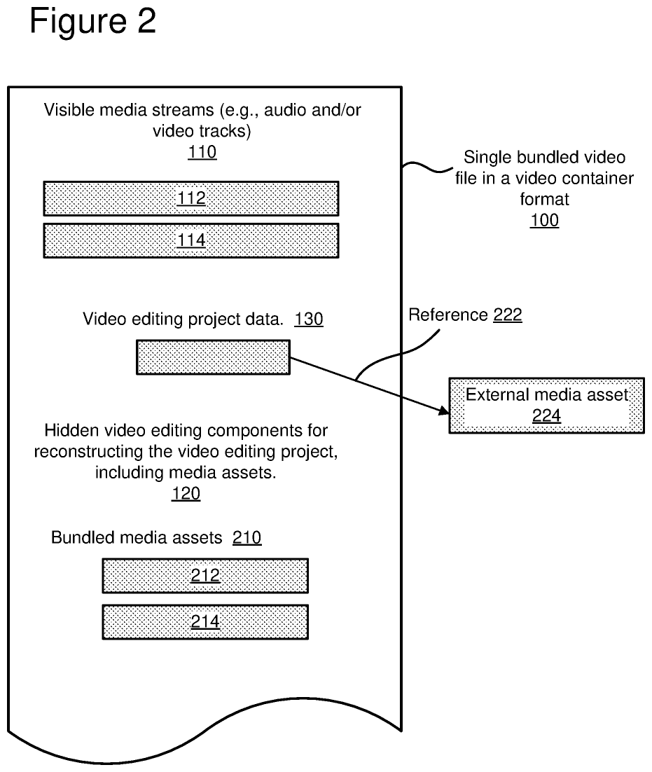

FIG. 2 is a diagram depicting how bundled media assets and external media assets are stored in the single bundled video file 100. In this example, the single bundled video file 100 contains bundled media assets 210. Specifically, there are two bundled media assets, which are identified as bundled media asset 212 and bundled media asset 214. For example, bundled media asset 212 could be a video clip (e.g., an encoded video data stream) and bundled media asset 214 could be an audio clip (e.g., an encoded audio data stream). The bundled media assets 210 can also include images and other types of media assets.

The single bundled video file 100 also contains the video editing project data 130. In the example depicted in FIG. 2, the video editing project data 130 contains media asset information identifying external media asset 224. In this example, the media asset information comprises a reference 222 (e.g., a pointer or URL) to the external media asset 224 (e.g., located on a remote server or remote video asset library).

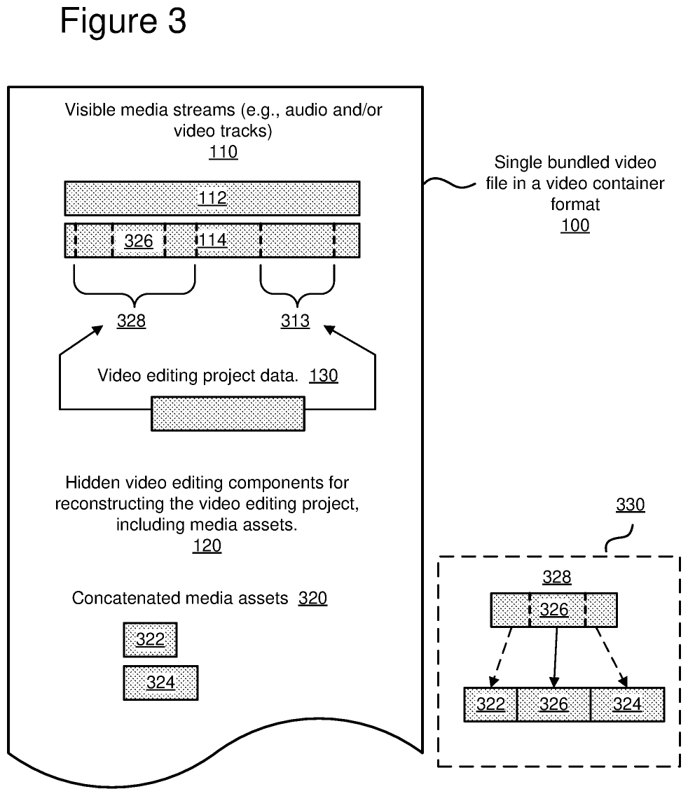

FIG. 3 is a diagram depicting how reconstructed media assets and concatenated media assets are stored in the single bundled video file 100. Specifically, the video editing project data 130 can be used to obtain reconstructed media assets and generate concatenated media assets.

In this example, the single bundled video file 100 identifies a particular reconstructed media asset using media asset information stored in the video editing project data 130, which identifies a portion 313 of visible media stream 114. When the video editing project is reconstructed, the identified portion 313 can be extracted from the visible media stream 114 and used as a video editing component (e.g., an audio or video clip) available for use on the timeline. Using this technique, the reconstructed media asset is not separately stored in the hidden video editing components 120, which is more efficient in terms of storage and bandwidth.

In this example, the single bundled video file 100 identifies a particular concatenated media asset using media asset information stored in the video editing project data 130, which identifies the components of the concatenated media asset. In this example, the concatenated media asset has three components: a first portion 322 that is stored as a hidden video editing component 120 within the singled bundled video file 100, a second portion 324 that is also stored as a hidden video editing component 120 within the singled bundled video file 100, and a third portion 326 that is obtained from the visible media stream 114. The video editing project data 130 stores information (e.g., media asset information) that identifies this example concatenated media asset and its three components, including identifying the third portion 326 and its location within the visible media stream 114. The entire concatenated media asset is depicted conceptually at 328. However, because the beginning and end portions of the concatenated media asset cannot be obtained directly from the visible media stream 114 (e.g., because they are occluded in some way, such as being part of a transition or having a title or other composited overlay) they are stored separately (in a non-occluded state) as hidden video editing components 120. To illustrate how the concatenated media asset is generated (e.g., when the video editing project is re-created), a break-out area 330 is depicted. As depicted in the break-out area 330, the concatenated media asset is generated (according to the video editing project data 130) by concatenating the first portion 322 (which represents the beginning segment), the third portion 326 (which is middle segment that is obtained from the visible media stream 114), and the second portion 324 (which represents the end segment). Using this technique, the concatenated media asset does not need to separately store the entire concatenated media asset, which is more efficient in terms of storage and bandwidth.

### Example Re-Creating a Video Editing Project Using a Single Bundled Video File

In the technologies described herein, video editing projects can be re-created using singled bundled video files. For example, video editing software that is programmed to understand the single bundled video file format can open a singled bundled video file and access the hidden video editing components stored within. The video editing software can then re-create a video editing project according to the information (e.g., visible media streams and/or hidden video editing components) stored within the single bundled video file.

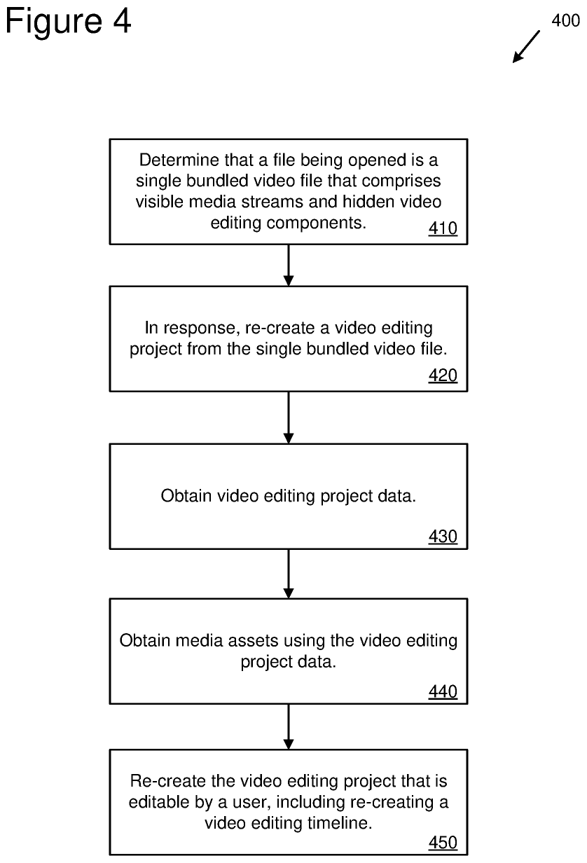

FIG. 4 is a is a flowchart of an example method 400 for managing video editing projects using single bundled video files, including re-creating a video editing project from a single bundled video file. At 410, a determination is made that a file being opened is a single bundled video file that comprises visible media streams, video editing project data, and hidden video editing components. For example, the file can be opened by video editing software (e.g., a locally installed video editing software program, web-based video editing software, a video editing service, etc.) that is programmed to access and understand the singled bundled video file format and the hidden video editing components stored within. In some implementations, a single bundled video file is identified by accessing the video editing project data and/or other metadata (e.g., checking for a key-value pair that identifies the file as a single bundled video file).

At 420, in response to determining that the file being opened is a single bundled video file, a video editing project is re-created from the single bundled video file. Re-creation of the video editing project uses, at least in part, the hidden video editing components. Re-creation of the video editing project comprises performing operations 430-450.

At 430, video editing project data is obtained from the single bundled video file. The video editing project data describes the video editing project (e.g., by describing structural information, such has properties of the video editing timeline, and information for obtaining various types of media assets).

At 440, media assets are obtained using, at least in part, the video editing project data from the single bundled video file. For example, the media assets can be bundled media assets, reconstructed media assets, external media assets, concatenated media assets, and/or other types of media assets.

At 450, the video editing project is re-created. The video editing project is re-created using, at least in part, the video editing project data and the media assets. Re-creating the video editing project includes re-creating a video editing timeline for the video editing project. The re-created video editing project is editable by a user.

After the video editing project has been re-created and is editable by the user (e.g., as described at 450), video editing commands can be received from the user and corresponding video editing operations can be performed. Once the user has completed editing the video editing project, the video editing project can be saved as a new single bundled video file. The new single bundled video file can comprise new visible media streams that have been exported from the edited video editing project and new hidden video editing components that represent the state of the video editing project as edited by the user.

In some implementations, when a single bundled video file is opened by video editing software that understands the format, the user is given the option to open the file as a regular media file (e.g., to access just the visible media streams) or to re-create the video editing project using, at least in part, the hidden video editing components. If the video editing project is to be re-created, then the hidden video editing components will be accessed and the media assets will be obtained (e.g., from bundled media assets, by obtaining external media assets, by reconstructing media assets, and/or by generating concatenated media assets). The video editing timeline will also be re-created and populated with the video editing elements.

### Example Saving a Video Editing Project Using a Single Bundled Video File

In the technologies described herein, video editing projects can be saved using singled bundled video files. For example, video editing software that is programmed to understand the single bundled video file format can be used to save a video editing project to a single bundled video file (e.g., upon completion of editing the video editing project). Saving the video editing project can comprise exporting visible media streams which are stored as visible media streams in the single bundled video file, and saving hidden video editing components for the video editing project which can be used to re-create the video editing project when the single bundled video file is later opened.

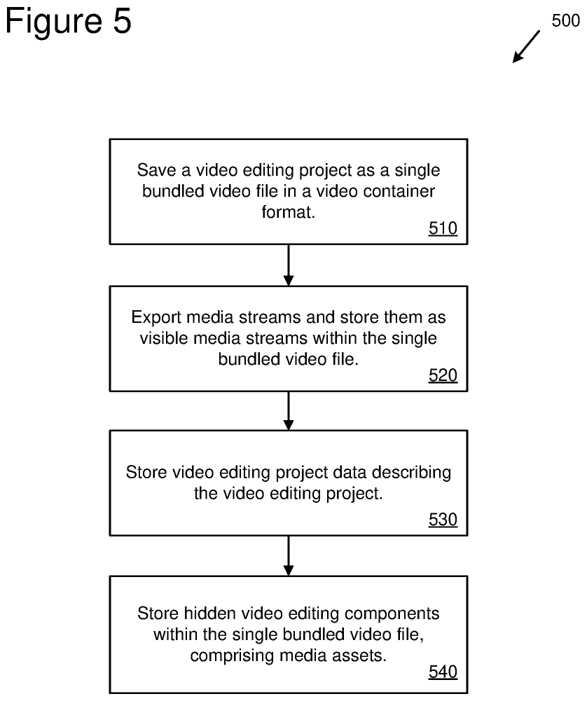

FIG. 5 is a is a flowchart of an example method 500 for managing video editing projects using single bundled video files, including saving a video editing project to a single bundled video file. At 510, a video editing project is saved as a singled bundled video file in a video container format. For example, saving of the video editing project can be initiated by a user of a video editing application (e.g., after the user has completed editing the video editing project). Saving of the video editing project as a single bundled video file comprises performing operations 520-540.

At 520, media streams are exported from the video editing project and stored as visible media streams within the single bundled video file. Typically, the media streams are encoded according to audio and/or video coding standards when they are exported and stored as visible media streams. For example, an exported video stream (e.g., an H.264 encoded video stream) and an exported audio stream (e.g., an AAC encoded audio stream) can be stored as visible video and audio tracks within the single bundled video file.

At 530, video editing project data is stored within the single bundled video file. The video editing project data describes the video editing project. For example, the video editing project data can include information (e.g., media asset information) describing how various types of media assets are obtained (e.g., external media assets, reconstructed media assets, concatenated media assets, etc.).

At 540, hidden video editing components are stored within the single bundled video file. The hidden video editing components comprise media assets (e.g., bundled media assets, portions of concatenated media assets that are stored separately, images, etc.).

In some implementations, saving a video editing project as a single bundled video file is performed by iterating over all the media assets used by the video editing project and identify the video editing elements (also referred to as track items) using them (e.g., multiple elements may use overlapping time intervals of the same media asset). For each element, a check is made to determine whether the media asset can be stored as an external media asset (e.g., as a stock media asset). If not, a check is made to determine whether the media asset can be represented as a reconstructed media asset that references a time interval of one of the visible media streams. A media asset can be represented as a reconstructed media asset when it is present in one of the visible media streams in a non-occluded state (e.g., not occluded by a motion title, a transition, a filter, a picture-in-picture overlay, or otherwise perceptually altered such as by cropping, etc.). If the media asset is not occluded (or perceptually altered) at all, the media asset will be stored in the single bundled video file as a reconstructed media asset. If the media asset is occluded for only part of the time, then it will be stored in the singled bundled video file as a concatenated media asset (i.e., only the time ranges during which the media asset is occluded will be stored as separate bundled media assets in the single bundled video file, with the remaining non-occluded time ranges being referenced). If the media asset is at least partially occluded the entire time, then it will be entirely represented as a bundled media asset and stored within the single bundled video file.

In some implementations, various pre-processing operations can be performed when saving a single bundled video file. For example, when a media asset will be fully or partially included as a hidden video editing component (e.g., as a bundled media asset or as part of a concatenated media asset), the media asset can be re-encoded. Re-encoding can be performed to reduce the size of the media asset by using a more efficient codec, altering the compression settings, and/or reducing the frame rate or resolution.

In some implementations, when a media asset is saved, it is padded to include a larger portion timewise (e.g., before and/or after the portion that is needed). For example, if a 10-second video clip is used as a video editing element on the timeline, then that 10-second video clip can be padded to include video content before and/or after (e.g., an extra 2 seconds on either side), which is then saved (e.g., as a 14-second bundled media asset). This technique allows additional flexibility when the video editing project is re-created as the user can expand the media asset by some amount. This additional padding could be a pre-configured setting and/or a user-configurable setting.

### Additional Examples

Example 1 is a computing device comprising: a processor, a network interface, and memory, the computing device configured to perform operations for managing video editing projects using single bundled video files, the operations comprising: determining that a file being opened is a single bundled video file, wherein the single bundled video file is compliant with a video container format, and wherein the single bundled video file comprises both visible media streams and hidden video editing components; responsive to determining that the file is a single bundled video file, re-creating a video editing project from the single bundled video file using, at least in part, the hidden video editing components, comprising: obtaining video editing project data describing the video editing project from the single bundled video file; obtaining media assets using, at least in part, the video editing project data from the singled bundled media file; and re-creating the video editing project using, at least in part, the video editing project data and the media assets, wherein re-creating the video editing project comprises re-creating a video editing timeline of the video editing project; wherein the re-created video editing project is editable by a user.

Example 2 includes the subject matter of Example 1, and further specifies that obtaining the media assets comprises: obtaining one or more bundled media assets that are stored within the single bundled video file, wherein the one or more bundled media assets are stored as one or more corresponding hidden tracks according to the video container format.

Example 3 includes the subject matter of any of Examples 1-2, and further specifies that obtaining the media assets comprises: obtaining indications of one or more external media assets from the video editing project data stored within the single bundled video file; and retrieving the one or more external media assets.

Example 4 includes the subject matter of any of Examples 1-3, and further specifies that obtaining the media assets comprises: reconstructing one or more media assets from the visible media streams using the video editing project data, wherein the one or more reconstructed media assets are extracted from the visible media streams; and including the one or more reconstructed media assets as video editing elements of the re-created video editing project.

Example 5 includes the subject matter of Example 4, and further specifies that the video editing project data comprises time intervals that reference the visible media streams and that identify the one or more media assets within the visible media streams.

Example 6 includes the subject matter of any of Examples 1-5, and further specifies that obtaining the media assets comprises: generating one or more concatenated media assets using the video editing project data, wherein each of the one or more concatenated media assets comprises: at least one bundled media asset stored as a hidden video editing component; and at least a portion of a visible media asset; and including the one or more concatenated media assets as video editing elements of the re-created video editing project.

Example 7 includes the subject matter of any of Examples 1-6, and further specifies that the visible media streams are one or more exported audio and/or video streams that are playable by a media player.

Example 8 includes the subject matter of any of Examples 1-7, and further specifies that the operations further comprise: receiving video editing commands from the user and performing corresponding video editing operations; saving the video editing project as a new single bundled video file, wherein the new single bundled video file comprises: new visible media streams that have been exported from the re-created video editing project; new video editing project data describing the video editing project as edited by the user, including any edited media assets; and new hidden video editing components that represent a state of the re-created video editing project as edited by the user.

Example 9 is a method, implemented by a computing device, for managing video editing projects using single bundled video files, the method comprising: saving a video editing project as a single bundled video file that is compliant with a video container format, wherein saving the video editing project comprises: exporting one or more media streams from the video editing project, wherein the one or more exported media streams are stored within the single bundled video file as one or more corresponding visible media streams; storing, within the single bundled video file, video editing project data describing the video editing project; and storing, within the single bundled video file, hidden video editing components, wherein the hidden video editing components comprise: media assets used in the video editing project; wherein the video editing project data and the hidden video editing components are usable to re-create the video editing project.

Example 10 includes the subject matter of Example 9, and further specifies that storing the hidden video editing components comprises storing one or more bundled media assets within the single bundled video file as one or more corresponding hidden tracks according to the video container format.

Example 11 includes the subject matter of any of Examples 9-10, and further specifies that storing the video editing project data comprises storing media asset information comprising indications of one or more external media assets.

Example 12 includes the subject matter of any of Examples 9-11, and further specifies that storing the video editing project data comprises storing media asset information for reconstructing one or more media assets from the one or more visible media streams.

Example 13 includes the subject matter of any of Examples 9-12, and further specifies that storing the video editing project data comprises: storing media asset information for generating one or more concatenated media assets, wherein the one or more concatenated media assets are generated, in part, using portions of the visible media assets; and storing at least a portion of each concatenated media asset as a bundled media asset within the hidden video editing components

Example 14 includes the subject matter of any of Examples 9-13, and further specifies that the method further comprises, before saving the video editing project: opening a file within a video editing application; determining that the file is the single bundled video file in the video container format; and responsive to determining that the file is the single bundled video file in the video container format, re-creating the video editing project.

Example 15 is a computer-readable storage media storing data for use by software being executed on a computing device, the data comprising: a single bundled video file compliant with a video container format, wherein the singled bundled video file is for a video editing project, the single bundled video file comprising: one or more visible media streams, wherein the one or more visible media streams are stored as one or more corresponding audio or video tracks according to the video container format, and wherein the one or more visible media streams are playable by a media player; video editing project data describing the video editing project; and hidden video editing components, wherein the hidden video editing components comprise: media assets used in the video editing project; and wherein the video editing project data and the hidden video editing components are usable to re-create the video editing project.

Example 16 includes the subject matter of Example 15, and further specifies that the media assets comprise one or more bundled media assets stored within the single bundled video file as one or more corresponding hidden tracks according to the video container format.

Example 17 includes the subject matter of any of Examples 15-16, and further specifies that the video editing project data comprises references to one or more external media assets.

Example 18 includes the subject matter of any of Examples 15-17, and further specifies that the video editing project data comprises information for reconstructing one or more media assets from the one or more visible media streams.

Example 19 includes the subject matter of any of Examples 15-18, and further specifies that the video editing project data comprises information for generating one or more concatenated media assets, wherein the one or more concatenated media assets are generated, in part, using portions of the visible media assets in combination with one or more of the media assets.

Example 20 includes the subject matter of any of Examples 1-19, and further specifies that the video container format is an MP4 container format.

Example 21 includes the subject matter of any of Examples 1-20, and further specifies that the video editing project runs within a browser-based video editing application.

### Computing Systems

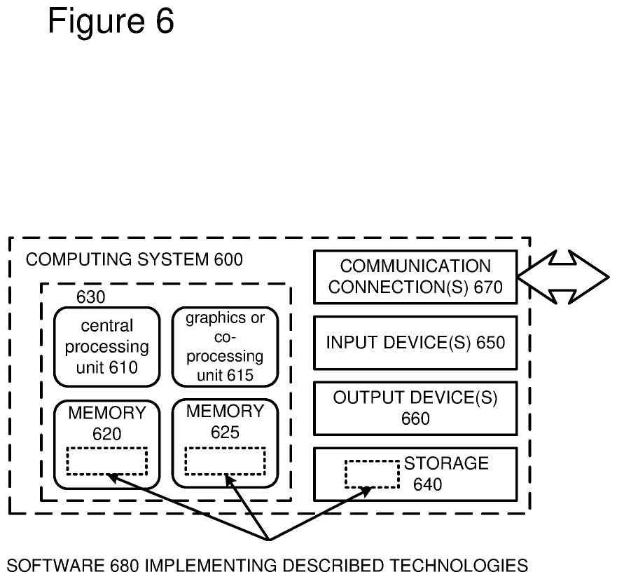

FIG. 6 depicts a generalized example of a suitable computing system 600 in which the described technologies may be implemented. The computing system 600 is not intended to suggest any limitation as to scope of use or functionality, as the technologies may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC), or any other type of processor. A processing unit can also comprise multiple processors. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more technologies described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more technologies described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The technologies can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud-Supported Environment

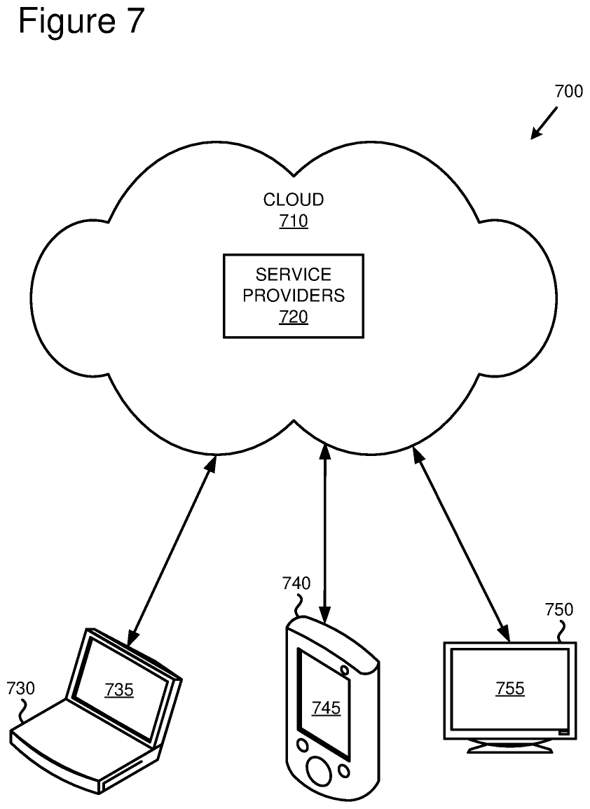

FIG. 7 illustrates a generalized example of a suitable cloud-supported environment 700 in which described embodiments, techniques, and technologies may be implemented. In the example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touchscreen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections, such as 670.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

1. A computing device comprising:
a processor;
a network interface; and
memory;
the computing device configured to perform operations for managing video editing projects using single bundled video files, the operations comprising:
determining that a file being opened is a single bundled video file, wherein the single bundled video file is compliant with a video container format, and wherein the single bundled video file comprises both visible media streams and hidden video editing components;
responsive to determining that the file is a single bundled video file, re-creating a video editing project from the single bundled video file using, at least in part, the hidden video editing components, comprising:
obtaining video editing project data describing the video editing project from the single bundled video file;
obtaining media assets using, at least in part, the video editing project data from the singled bundled video file, wherein the obtaining the media assets comprises:
obtaining indications of one or more external media assets, among the media assets, the indications of the one or more external media assets being stored as part of the video editing project data within the single bundled video file; and
retrieving the one or more external media assets using the indications stored as part of the video editing project data within the single bundled video file, the one or more external media assets being external to the single bundled video file; and
re-creating the video editing project using, at least in part, the video editing project data and the media assets, wherein re-creating the video editing project comprises re-creating a video editing timeline of the video editing project;
wherein the re-created video editing project is editable by a user.

2. The computing device of claim 1, wherein obtaining the media assets further comprises:
obtaining one or more bundled media assets, among the media assets, that are stored within the single bundled video file, wherein the one or more bundled media assets are stored as one or more corresponding hidden tracks according to the video container format.

3. (canceled)

4. The computing device of claim 1, wherein obtaining the media assets further comprises:
extracting one or more reconstructed media assets, among the media assets, from the visible media streams using the video editing project data, wherein the one or more reconstructed media assets are extracted from the visible media streams; and
including the one or more reconstructed media assets as video editing elements of the re-created video editing project.

5. The computing device of claim 4, wherein the video editing project data comprises time intervals that reference the visible media streams and that identify the one or more reconstructed media assets within the visible media streams.

6. The computing device of claim 1, wherein obtaining the media assets further comprises:
generating one or more concatenated media assets, among the media assets, using the video editing project data, wherein each of the one or more concatenated media assets comprises:
at least one bundled media asset stored as a hidden video editing component; and
at least a portion of a visible media asset; and
including the one or more concatenated media assets as video editing elements of the re-created video editing project.

7. The computing device of claim 1, wherein the single bundled video file is backward-compatible with a media player that is not configured to process the hidden video editing components, and wherein the visible media streams are one or more exported audio and/or video streams that are playable from the single bundled video file by the media player that is not configured to process the hidden video editing components.

8. The computing device of claim 1, wherein the video container format is an MP4 container format.

9. The computing device of claim 1, the operations further comprising:
receiving video editing commands from the user and performing corresponding video editing operations;
saving the video editing project as a new single bundled video file, wherein the new single bundled video file comprises:
new visible media streams that have been exported from the re-created video editing project;
new video editing project data describing the video editing project as edited by the user, including any edited media assets; and
new hidden video editing components that represent a state of the re-created video editing project as edited by the user.

10. A method, implemented by a computing device, for managing video editing projects using single bundled video files, the method comprising:
saving a video editing project as a single bundled video file that is compliant with a video container format, wherein saving the video editing project comprises:
exporting one or more media streams from the video editing project, wherein the one or more exported media streams are stored within the single bundled video file as one or more corresponding visible media streams;
storing, within the single bundled video file, video editing project data describing the video editing project; and
storing, within the single bundled video file, hidden video editing components, wherein the hidden video editing components comprise:
bundled media assets used in the video editing project;
wherein the single bundled video file is backward-compatible with a media player that is not configured to process the hidden video editing components, the one or more corresponding visible media streams being playable from the single bundled video file by the media player that is not configured to process the hidden video editing components; and
wherein the video editing project data and the hidden video editing components are also usable by a video editor to re-create the video editing project.

11. The method of claim 10, wherein storing the hidden video editing components comprises storing the bundled media assets within the single bundled video file as corresponding hidden tracks according to the video container format.

12. The method of claim 10, wherein storing the video editing project data comprises storing, as part of the video editing project data within the single bundled video file, media asset information comprising indications of one or more external media assets the one or more external media assets being external to the single bundled video file.

13. The method of claim 10, wherein storing the video editing project data comprises storing media asset information for reconstructing extracting one or more reconstructed media assets from the one or more visible media streams.

14. The method of claim 10, wherein storing the video editing project data comprises:
storing media asset information for generating one or more concatenated media assets, wherein the one or more concatenated media assets are generated, in part, using portions of the visible media assets.

15. The method of claim 10, further comprising, before saving the video editing project:
opening a file within a video editing application;
determining that the file is the single bundled video file in the video container format; and
responsive to determining that the file is the single bundled video file in the video container format, re-creating the video editing project.

16. A computer-readable storage media storing data for use by software being executed on a computing device, the data comprising:
a single bundled video file compliant with a video container format, wherein the single bundled video file is for a video editing project, the single bundled video file comprising:
one or more visible media streams, wherein the one or more visible media streams are stored as one or more corresponding audio or video tracks according to the video container format;
video editing project data describing the video editing project; and
hidden video editing components, wherein the hidden video editing components comprise:
bundled media assets used in the video editing project; and
wherein the single bundled video file is backward-compatible matter with a media player that is not configured to process the hidden video editing components, the one or more visible media streams being playable from the single bundled video file by the media player that is not configured to process the hidden video editing components; and
wherein the video editing project data and the hidden video editing components are also usable by a video editor to re-create the video editing project.

17. The computer-readable storage media of claim 16, wherein the bundled media assets are stored within the single bundled video file as corresponding hidden tracks according to the video container format.

18. The computer-readable storage media of claim 16, wherein the video editing project data comprises, as part of the video editing project data within the single bundled video file, references to one or more external media assets, the one or more external media assets being external to the single bundled video file.

19. The computer-readable storage media of claim 16, wherein the video editing project data comprises information for extracting one or more reconstructed media assets from the one or more visible media streams.

20. The computer-readable storage media of claim 16, wherein the video editing project data comprises information for generating one or more concatenated media assets, wherein the one or more concatenated media assets are generated, in part, using portions of the visible media assets in combination with one or more of the bundled media assets.

21. The computer-readable storage media of claim 19, wherein the video editing project data comprises time intervals that reference the visible media streams and that identify the one or more reconstructed media assets within the visible media streams.
